(19) United States
(12) Patent Application Publication
(10) Pub. No.: US 2026/0195135 A1
(43) Pub. Date: Jul. 9, 2026

(54) TWO-LEVEL RESERVATION STATION

(71) Applicant: Google LLC, Mountain View, CA (US)

(72) Inventors: Shivam Priyadarshi, San Jose, CA (US); John Michael Esper, Austin, TX (US)

(21) Appl. No.: 19/127,669

(22) PCT Filed: Nov. 8, 2022
(86) PCT No.: PCT/US2022/049270

§ 371 Date: May 6, 2025

(51) Int. Cl. G06F 9/38; G06F 12/0802

(52) U.S. Cl. CPC G06F 9/3838; G06F 12/0802

(57) ABSTRACT

Methods, systems, and apparatus for a computing device comprising; a plurality of processing cores; and a reservation station comprising circuitry configured to coordinate the selection of instructions for out-of-order execution on the plurality of processing cores, wherein the reservation station comprises a waiting buffer and a plurality of clusters, wherein upon the reservation station predicting that a load instruction will result in a cache miss, the reservation station is configured to execute the load instruction using a cluster of the plurality of clusters and to store one or more dependent instructions of the load instruction in the waiting buffer, and wherein upon the load instruction completing execution, the reservation station is configured to obtain the dependent instructions from the waiting buffer and execute the dependent instructions using the plurality of clusters.

### BACKGROUND

This specification relates to devices that contain one or more reservation stations (RSVs) that can assist with out-of-order (OoO) instruction execution on computing devices.

In modern out-of-order (OoO) processors, instruction throughput (e.g., instructions per cycle (IPC)) typically improves by increasing the OoO window size. Reservation stations (RSVs) are one of the components that typically constrain the window size. Larger RSVs can extract instruction and memory level parallelism which helps in improving the IPC.

However, increasing RSV size creates cycle time challenges and constrains the frequency. The Wakeup-Select timing path, which is tied to RSV size, is one of the tightest timing paths in modern OoO CPUs and typically constrains overall CPU frequency. Increasing RSV size puts pressure on each component on the Wakeup-Select path. For example, wakeup delay increases by increasing the RSV size because load on tag broadcast wire increases. Select delay increases because more instructions are participating in the selection process and determining selection priority among them takes longer. Since IPC and frequency both contribute to overall performance, simply increasing RSV size may not result in higher overall performance.

### SUMMARY

This specification describes systems and methods for implementing an RSV that has multiple levels to increase the “effective capacity” in a cycle-time friendly fashion.

“RSV clustering” is a process in which the RSV is divided into smaller “clusters” or “groupings” each designed to process specific types of instructions. In the instance where all instructions are fed to all clusters, this structure is referred to as a “fully unified”, or “monolithic”, RSV. On the other hand, a “fully distributed”, or “fragmented”, RSV is where instructions are fed only to their specified clusters. There are advantages and disadvantages of both structures with respect to IPC and cycle time. The two-level RSV organization presented in this specification outlines a device that does not rely on a “fully distributed” or a “fully unified” design to obtain similar performance benefits offered by each structure.

This two-level RSV design leverages the fact that most frequently, the RSVs are filled by instructions that have missed in the Last Level Cache (LLC) and their dependents. The LLC is defined as the last cache before the CPU accesses memory. Generally speaking, it may take many cycles (for example, over 100) to serve instructions or dependents that miss LLC. This can cause a chain reaction where RSVs are prevented from serving newer instructions. In other words, the “queue” of the RSV may be occupied by these instructions that miss LLC, and their dependents, and thus the RSV is prevented from storing instructions that may be processed more efficiently.

In order to overcome this issue, this system seeks to predict what instructions will miss LLC proactively, and steer these instructions'dependents to a separate cycle-friendly structure. In some implementations, this structure may be referred to as a Waiting Buffer (WB). This WB is a separate structure from usual RSV clustering. In some implementations, the RSV is divided into two levels; the first consisting of the WB, and the second containing one or more RSV clusters. In some implementations, instructions predicted to miss LLC will steer their dependents to the WB in level one, as opposed to being passed directly to the RSV clusters in level two.

### BRIEF DESCRIPTION OF THE DRAWINGS

FIG. 1 is an overview of an example system implementation.

FIG. 2 is a detailed view of an example system implementation.

FIG. 3 is an example process where instructions are processed by the example system implementation.

FIG. 4 is an example process where the LLC predictor's estimation logic is refined.

### DETAILED DESCRIPTION

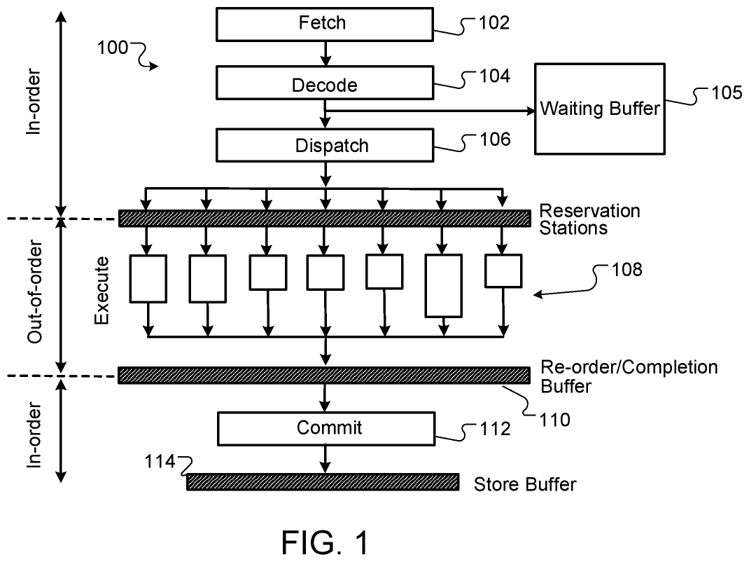

FIG. 1 is an overview of an example system. The system 100 has a fetch module 102, a decode module 104, a waiting buffer (WB) 105, a dispatch module 106, one or more RSVs 108, a reorder buffer 110, a commit module 112, and a store buffer 114. The various “modules” as mentioned above may be implemented using various logic circuitry components, to include AND, OR, NOT, NAND, or XOR gates. Other implementations may choose to use other circuitry components.

The fetch module 102 retrieves incoming instructions for decoding. The decode module 104 analyzes the incoming functions to determine their consumers. In some implementations, the output of the decode module 104 is used to determine if decoded instructions correspond to an instruction that is likely to miss LLC. Once determining that an instruction is likely to miss LLC, a bank in the WB 105 is allocated for that instruction's dependents. If an instruction is not a likely LLC miss, or if the instruction has met the requirements to leave the WB 105, it is then sent to a dispatching module 106 which sends the instruction to the RSVs 108. The RSVs 108 can take various forms between a fully distributed and fully unified system. The RSVs 108 may also employ various forms of clustering, where groups of instruction types may be assigned to a certain number of RSVs 108. After being called from the RSVs 108, the instructions are then processed by a reorder buffer 110 and a commit module 112 before reaching the store buffer 114.

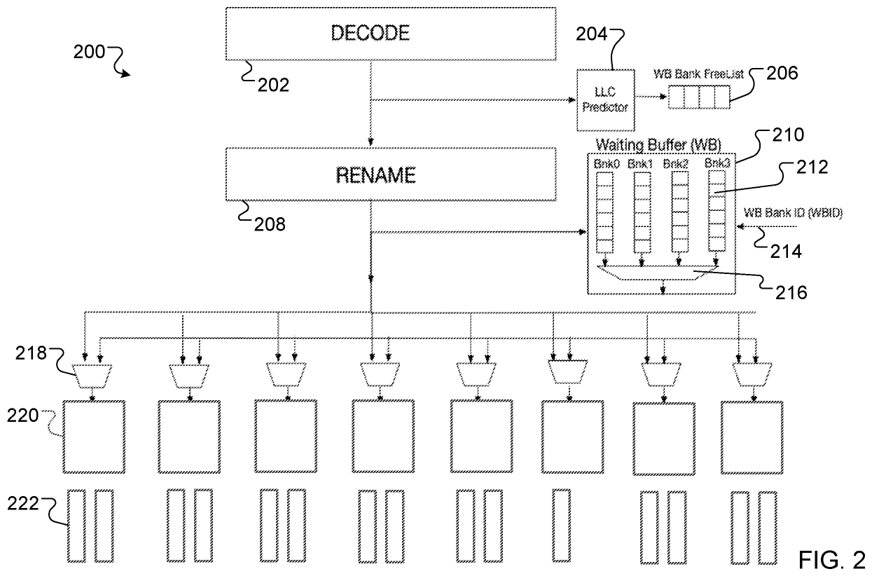

FIG. 2 is a detailed view of an example system implementation 200. The system 200 includes a decode module 202, a LLC predictor 204, and WB free-list 206, a rename module 208, a WB 210, WB banks 212, a “WB BankID” 214, a WB multiplexer 216, one or more RSV multiplexers 218, one or more RSV clusters 220, and one or more execution lanes 222.

A LLC predictor 204 is used to determine which instructions will likely miss LLC. In some implementations, this prediction may occur during the decode module 202 of the RSV. Prior to use, the LLC predictor 204 may undergo initial training on what instructions have a high probability of missing LLC. Upon the LLC predictor 204 detecting that an instruction will miss LLC, the instruction will claim a bank 212 in the WB 210 if an open BankID 214 is available as identified by the WB free-list 206. Additional identification may be assigned to the instruction at this time, for example, tags for physical register number (PRN) and a “BankIDValid”. In some implementations, this process may be handled by the rename module 208.

In some implementations, the WB 210 may be split into a certain number of banks 212. The number of banks 212 may be further divided into a number of entries, each of which may be occupied by a single instruction, and are structured such that they are first-in-first-out (FIFO). The FIFO structure allows a bank-level wakeup (i.e. all the instructions in the same bank 212) which reduces design complexity. Other implementations within the scope of the claims may use other WB 210 structures or processes.

When departing the WB 210, the instruction chain will leave in a specific format, for example, in allocation order based on FIFO. In some implementations, this process may be handled by a WB multiplexer 216. Instructions that leave the WB 210 may then be provided to the RSV clusters 220. In implementations where multiple instruction types are handled by the same RSV cluster 220, an RSV multiplexer 218 may be used to distribute the instructions to the appropriate RSV. Instructions ready for execution are then assigned an execution lane 222 by the RSV. In some implementations, the individual RSV clusters 220 are configured to process different instruction types. For example, each RSV cluster can be configured to process a different type of instruction or instruction class. For example, different RSV clusters 220 can be assigned to process loads, stores, functional operations, basic mathematical operations, and complex mathematical operations, respectively. Other alternative implementations can use any appropriate arrangement of RSV clusters to instruction types or classes.

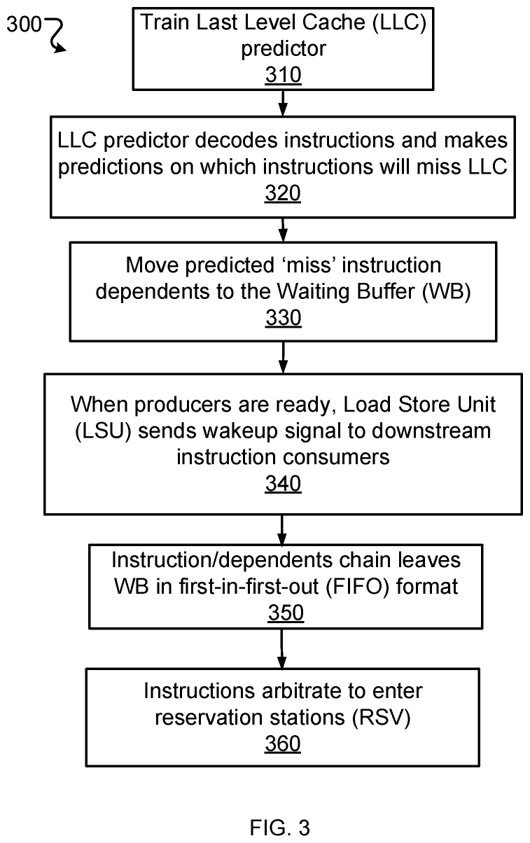

FIG. 3 is a flowchart of an example process for using a waiting buffer on a predicted load miss. The example process can be performed by any appropriate processor configured to operate in accordance with this specification.

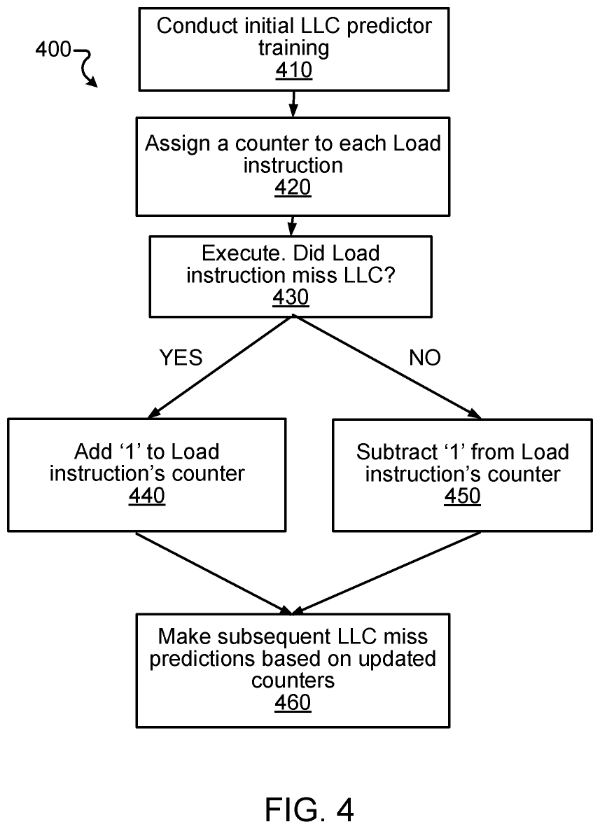

The LLC predictor may undergo initial training on what instructions have a high probability of missing the LLC (310). In some implementations, this training may be based on known program counter (PC) data. Training is described in more detail below with reference to FIG. 4. The predictions used by the LLC predictor 204 can also be refined as the RSV operates to better predict which instructions will miss LLC. In some implementations, the LLC predictor 204 may include a table with multiple entries, each of which has an N bit saturating counter. This table may be indexed by various means, including, load instruction address, hashes of load instruction address, global load hit/miss history (GLHR), load path history, or other parameters readily obtainable from the PC. This table can also be indexed through a combination of the above parameters.

In the implementation where GLHR is used, the GLHR may contain an “N” bit shift register that is updated on instruction LLC miss prediction time. If an instruction is predicted to miss LLC, a “1” will be assigned to the GLHR. Alternatively, if an instruction is expected to be hit in the LLC, a “0” will be assigned to the GLHR. In another implementation where load path history is used to update the LLC predictor 204, this operation may comprise a hash of PC bits from “N” previous load instructions.

Additionally, in multi-core systems where LLC hit/miss information is not readily available, a proxy may be used to train the LLC predictor 204. In this case, the number of cycles spent by an instruction at the head of the reorder buffer (ROB) may be used to train the LLC predictor 204. A number of cycles may be assigned, for example 50, past which the instruction is considered a miss and the respective counter is increased. Otherwise, the instruction will be considered a hit and the respective counter will be decreased.

After initial training, the LLC predictor 204 decodes instructions during operation and makes predictions on which instructions will miss LLC (320). If an instruction is predicted to miss LLC by the LLC predictor 204, the instruction's dependents will be moved into a bank 212 within the WB 210 (330). Upon entry into the WB 210, the dependent instructions can be assigned a “BankID” 214 that corresponds to its destination logical register number (LRN). This information may be arranged in an easy-to-reference format, for example, a look-up table. When dependent instructions are detected that correspond to the same LRN, the BankID 214 can then be used to place the dependent instructions in the same bank in the WB 210 as the preceding instruction. If a dependent has more than one preceding instruction that allocated a unique bank in the WB, the system may follow a predetermined response, for example, allocating the dependent instruction to the bank 212 in the WB 210 that has the lowest occupancy.

The BankID 214 for each instruction can also be shared with the Load Store Unit (LSU). Upon detecting that an instruction is ready to leave the WB 210, for example, because the load instruction has completed, a “wake-up” is sent by the LSU to all the dependent instructions in the same bank 212 (340). Additionally, the LSU may take other actions. For example, the LSU could send an advance warning to LRNs or other components that a wake-up is in progress. The LSU may also trigger an early departure for the instruction chain from the WB 210. When departing the WB 210, the instruction chain will leave in a specific format, for example, in allocation order based on FIFO (350). There is no limit to how many instruction chains may be woken up per cycle in this method. Other implementations within the scope of the claims may utilize a different method of wake-up, or may cause the LSU to execute different actions.

If multiple instruction chains are woken up in the same cycle, the system may follow a specific arbitration process to control how instructions depart the WB 210 (360). In some implementations, a round-robin may be conducted to determine the order. In other implementations, an age-based method may be preferred, where the older instruction banks 212 have priority. Additionally, this age preference may be extended to other instructions not assigned to the WB 210, such that instruction chains exiting the WB 210 have preference over instructions exiting decode 202 directly.

FIG. 4 is a flowchart of an example process 400 for refining an LLC predictor. The example process can be performed by any appropriate processor configured in accordance with this specification. For example, a processor can perform the example process during instruction execution in order to continually refine the LLC predictor.

Following initial LLC predictor training (410) as described in FIG. 3, it may be desirable to refine aspects of the LLC predictor's estimation logic to better identify problem instructions. In some implementations, a counter may be assigned to each load instruction (420) to form an entry table. In some cases, this table can be originally indexed based on a hash of the load instruction's PC. Other implementations may choose to use a “tagged” LLC predictor that utilizes a Content-Addressable Memory (CAM) structure that performs a comparison of load instruction tags. During execution, the load instructions are monitored to determine if any miss LLC (430).

Upon detecting that a load instruction has missed LLC (430), the counter assigned to the load instruction is increased by a fixed number (440). In some implementations, this number may be an integer (e.g. “1”). In the case where the load instruction does not miss LLC, the counter assigned to the load instruction is lowered by a fixed number (450). In some implementations, this number may be an integer (e.g. “1”). After updates to the load instructions'counters have been made, the system then continues to execute (460) using the updated counters.

Described above is one example implementation for updating the LLC predictor logic. Other implementations may choose to use a different variation of the described process, for example, increasing the counter in a different manner. Other implementations may choose to use another process entirely, to include using other data that is available to the LLC predictor 204 from the computing system.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e. g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

In addition to the embodiments described above, the following embodiments are also innovative:

Embodiment 1 is a computing device comprising:
a plurality of processing cores; and
a reservation station comprising a waiting buffer, a plurality of clusters, and circuitry configured to coordinate selection of instructions for out-of-order execution on the plurality of processing cores, wherein the reservation station is configured to:
   predict that a load instruction will result in a cache miss,
   upon predicting that a load instruction will result in a cache miss, i) execute the load instruction using a cluster of the plurality of clusters and ii) store one or more dependent instructions of the load instruction in the waiting buffer, and
   upon completion of executing the load instruction, i) obtain one or more of the dependent instructions from the waiting buffer and ii) execute the one or more dependent instructions using the plurality of clusters.

Embodiment 2 is the computing device of embodiment 1, wherein the waiting buffer comprises a plurality of banks, and wherein storing the one or more dependent instructions of the load instruction comprises storing all dependent instructions of the load instruction in a same bank of the waiting buffer.

Embodiment 3 is the computing device of embodiment 2, wherein each bank entry of the waiting buffer comprises a logical register number, a physical register number, a bank id, and a validity value.

Embodiment 4 is the computing device of embodiment 3, wherein each bank is organized as a first-in-first-out queue.

Embodiment 5 is the computing device of any one of embodiments 1-4, wherein the reservation station further comprises prediction circuitry that is configured to generate a prediction of whether the load instruction will result in a cache miss.

Embodiment 6 is the computing device of embodiment 5, wherein the prediction circuitry comprises a counter incremented by global load hit/miss history.

Embodiment 7 is the computing device of embodiment 5, wherein the prediction circuitry comprises the number of cycles spent by an instruction at the head of a reorder buffer.

Embodiment 8 is the computing device of embodiment 5, wherein the prediction circuitry comprises hash load.

Embodiment 9 is the computing device of any one of embodiments 1-8, wherein the cache miss is a miss in a last-level cache of the computing device.

Embodiment 10 is the computing device of any one of embodiments 1-9, wherein two or more clusters of the plurality of clusters are dedicated to executing a different mix of instruction types.

Embodiment 11 is the computing device of embodiment 10, wherein a first cluster is dedicated to executing simple instructions that execute in a single cycle and branch instructions.

Embodiment 12 is the computing device of embodiment 11, wherein a second cluster is dedicated to executing simple instructions and multi-cycle instructions.

Embodiment 13 is the computing device of any one of embodiments 1-12, wherein the reservation station is configured to perform bank-level arbitration if multiple banks are activated on a same clock cycle.

Embodiment 14 is a method performed by a computing device comprising a plurality of processing cores, a reservation station comprising a waiting buffer, a plurality of clusters, and circuitry configured to coordinate selection of instructions for out-of-order execution on the plurality of processing cores, the method comprising:
predicting, by the reservation station, that a load instruction will result in a cache miss,
upon predicting that a load instruction will result in a cache miss, i) executing the load instruction using a cluster of the plurality of clusters and ii) storing one or more dependent instructions of the load instruction in the waiting buffer, and
upon completion of executing the load instruction, i) obtaining one or more of the dependent instructions from the waiting buffer and ii) executing the one or more dependent instructions using the plurality of clusters.

Embodiment 15 is the method of embodiment 14, wherein the waiting buffer comprises a plurality of banks, and wherein storing the one or more dependent instructions of the load instruction comprises storing all dependent instructions of the load instruction in a same bank of the waiting buffer.

Embodiment 16 is the method of embodiment 15, wherein each bank entry of the waiting buffer comprises a logical register number, a physical register number, a bank id, and a validity value.

Embodiment 17 is the method of embodiment 16, wherein each bank is organized as a first-in-first-out queue.

Embodiment 18 is the method of any one of embodiments 14-17, wherein the reservation station further comprises prediction circuitry that is configured to generate a prediction of whether the load instruction will result in a cache miss.

Embodiment 19 is the method of embodiment 18, wherein the prediction circuitry comprises a counter incremented by global load hit/miss history.

Embodiment 20 is one or more non-transitory computer storage media encoded with computer program
instructions that when executed by one or more computers cause the one or more computers to perform operations comprising:
   predicting, by a reservation station, that a load instruction will result in a cache miss,
   upon predicting that a load instruction will result in a cache miss, i) executing the load instruction using a cluster of a plurality of clusters and ii) storing one or more dependent instructions of the load instruction in a waiting buffer, and
   upon completion of executing the load instruction, i) obtaining one or more of the dependent instructions from the waiting buffer and ii) executing the one or more dependent instructions using the plurality of clusters.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A computing device comprising:
a plurality of processing cores; and
a reservation station comprising a waiting buffer, a plurality of clusters, and circuitry configured to coordinate selection of instructions for out-of-order execution on the plurality of processing cores, wherein the reservation station is configured to:
predict that a load instruction will result in a cache miss,
upon predicting that a load instruction will result in a cache miss, i) execute the load instruction using a cluster of the plurality of clusters and ii) store one or more dependent instructions of the load instruction in the waiting buffer, and
upon completion of executing the load instruction, i) obtain one or more of the dependent instructions from the waiting buffer and ii) execute the one or more dependent instructions using the plurality of clusters.

2. The computing device of claim 1, wherein the waiting buffer comprises a plurality of banks, and wherein storing the one or more dependent instructions of the load instruction comprises storing all dependent instructions of the load instruction in a same bank of the waiting buffer.

3. The computing device of claim 2, wherein each bank entry of the waiting buffer comprises a logical register number, a physical register number, a bank id, and a validity value.

4. The computing device of claim 3, wherein each bank is organized as a first-in-first-out queue.

5. The computing device of claim 1, wherein the reservation station further comprises prediction circuitry that is configured to generate a prediction of whether the load instruction will result in a cache miss.

6. The computing device of claim 5, wherein the prediction circuitry comprises a counter incremented by global load hit/miss history.

7. The computing device of claim 5, wherein the prediction circuitry comprises the number of cycles spent by an instruction at the head of a reorder buffer.

8. The computing device of claim 5, wherein the prediction circuitry comprises hash load.

9. The computing device of claim 1, wherein the cache miss is a miss in a last-level cache of the computing device.

10. The computing device of claim 1, wherein two or more clusters of the plurality of clusters are dedicated to executing a different mix of instruction types.

11. The computing device of claim 10, wherein a first cluster is dedicated to executing simple instructions that execute in a single cycle and branch instructions.

12. The computing device of claim 11, wherein a second cluster is dedicated to executing simple instructions and multi-cycle instructions.

13. The computing device of claim 1, wherein the reservation station is configured to perform bank-level arbitration if multiple banks are activated on a same clock cycle.

14. A method performed by a computing device comprising a plurality of processing cores, a reservation station comprising a waiting buffer, a plurality of clusters, and circuitry configured to coordinate selection of instructions for out-of-order execution on the plurality of processing cores, the method comprising:
predicting, by the reservation station, that a load instruction will result in a cache miss,
upon predicting that a load instruction will result in a cache miss, i) executing the load instruction using a cluster of the plurality of clusters and ii) storing one or more dependent instructions of the load instruction in the waiting buffer, and
upon completion of executing the load instruction, i) obtaining one or more of the dependent instructions from the waiting buffer and ii) executing the one or more dependent instructions using the plurality of clusters.

15. The method of claim 14, wherein the waiting buffer comprises a plurality of banks, and wherein storing the one or more dependent instructions of the load instruction comprises storing all dependent instructions of the load instruction in a same bank of the waiting buffer.

16. The method of claim 15, wherein each bank entry of the waiting buffer comprises a logical register number, a physical register number, a bank id, and a validity value.

17. The method of claim 16, wherein each bank is organized as a first-in-first-out queue.

18. The method of claim 14, wherein the reservation station further comprises prediction circuitry that is configured to generate a prediction of whether the load instruction will result in a cache miss.

19. The method of claim 18, wherein the prediction circuitry comprises a counter incremented by global load hit/miss history.

20. One or more non-transitory computer storage media encoded with computer program
instructions that when executed by one or more computers cause the one or more computers to perform operations comprising:
predicting, by a reservation station, that a load instruction will result in a cache miss,
upon predicting that a load instruction will result in a cache miss, i) executing the load instruction using a cluster of a plurality of clusters and ii) storing one or more dependent instructions of the load instruction in a waiting buffer, and
upon completion of executing the load instruction, i) obtaining one or more of the dependent instructions from the waiting buffer and ii) executing the one or more dependent instructions using the plurality of clusters.
